(19) United States
(12) Patent Application Publication
(10) Pub. No.: US 2013/0105626 A1
(43) Pub. Date: May 2, 2013

(54) CHANGING CUBICLE IN AN AIRCRAFT AND METHOD FOR RETROFITTING AN AIRCRAFT WITH A CHANGING CUBICLE

(71) Applicant: DIEHL AIRCABIN GMBH, Laupheim (DE)

(72) Inventors: Christiane DREWS, Muenchen (DE); Joerg FILIPIAK, Blankenheim (DE); Florian HESSELBACH, Blaustein (DE); Markus KLINGSEIS, Biberach (DE); Thomas C. RAIFF, Illerkirchberg (DE); Silvan FIEDLER, Ulm (DE); Heike BARKOW, Ulm (DE)

(73) Assignee: DIEHL AIRCABIN GMBH, Laupheim (DE)

(21) Appl. No.: 13/662,440

(22) Filed: Oct. 27, 2012

(30) Foreign Application Priority Data
Oct. 29, 2011 (DE) 102011117480.3
Mar. 20, 2012 (DE) 102012005712.1

(51) Int. Cl. B64D 11/00; B23P 17/04

(52) U.S. Cl. 244/118.5; 29/401.1

(57) ABSTRACT

The invention relates to a changing cubicle in an aircraft (14), said changing cubicle comprising outer walls (4) that are opaque, at least in part, and being designed with an access opening (5) that can be closed, at least in part, wherein the changing cubicle (1) can be fastened to an aircraft cabin (9) by a fastening means and can be brought from a first state into a second state, wherein, in the first state, the outer walls (4) of the changing cubicle (1) are collapsed such that passengers can embark or disembark and, in the second state, passengers can change clothes. The invention further relates to a method for retrofitting an aircraft cabin (9) of an aircraft (14) with a changing cubicle (1).

### FIELD OF THE INVENTION

The invention relates to a changing cubicle in an aircraft and to a method for retrofitting an aircraft with a changing cubicle.

### BACKGROUND OF THE INVENTION

At the start of a long-haul flight, many passengers on an aircraft have the need to change into comfortable clothing so that, in addition to the obvious gain in comfort, their original clothes, which are often of premium quality, are prevented from becoming dirtied or creased. Before landing at their destination, passengers then want to change back into their normal clothes. Some airlines already support this in part by distributing pyjamas in business class. The only current possibility of a changing location is provided by the misuse of the toilets or lavatories as a changing cubicle. This has a number of disadvantages. The lavatories are blocked for their proper purpose. In addition, the design and ergonomics of the lavatories are only suitable to a limited extent for the changing of clothes, since there is a lack of freedom of movement, there is no seating, and there are no surfaces on which objects can be placed. Lastly, lavatories do not provide the ideal environment for changing clothes, particularly after a long-haul flight, since they may be tainted by offensive smells for example and may be compromised in terms of hygiene.

There is thus a need in the art to create changing possibilities in an aircraft that are suitable specifically for long-haul flights.

### DISCLOSURE OF THE INVENTION

The object of the invention is therefore to create a changing cubicle in an aircraft and to specify a method for retrofitting an aircraft with a changing cubicle, which overcome the disadvantages detailed in the introduction and which can be used easily in an aircraft.

This object is achieved by the features of Patent Claims 1 and 13. Further advantageous embodiments of the invention are disclosed in each of the dependent claims. These features can be combined with one another in any technically expedient manner. The description characterizes and specifies the invention to a greater extent, in particular in conjunction with the drawing.

The changing cubicle according to the invention is used in an aircraft, wherein the changing cubicle comprises outer walls that are opaque, at least in part, and is designed with an access opening that can be closed, at least in part. The changing cubicle can be fastened to an aircraft cabin by a fastening means. It can be brought from a first state into a second state, wherein, in the first state, the outer walls of the changing cubicle are collapsed such that passengers can embark or disembark and, in the second state, passengers can change clothes.

In accordance with the invention, a changing cubicle is installed such that the passengers are not hindered when embarking or disembarking. The changing cubicle can be collapsed accordingly and can be brought from a collapsed state into an opened state. It is thus possible to arrange the changing cubicle wherever the passengers normally embark or disembark. Since this space has to be provided anyway, no area provided for seating is used. The changing cubicle is provided once the flight is underway, and therefore the passengers no longer have to do without this comfort during long-haul flights in particular, and the lavatories are no longer misused.

In a further embodiment of the invention, the outer walls of the changing cubicle can be folded up.

The changing cubicle can accordingly be activated by cabin crew after take-off and before landing so as to provide an opportunity for passengers to change clothes.

In a further embodiment of the invention, the outer walls of the changing cubicle are formed of a plurality of rectangular panels, which can be transferred by means of a folding device from the first state into the second state.

This approach allows a space-saving arrangement of the changing cubicle in the folded up state and can be easily opened, without having to go to too much effort to install the changing cubicle.

In a further embodiment of the invention, the folding device is formed by means of hinges, which are arranged between the panels and have a fixing mechanism, which locks the outer walls releasably in the second state.

This approach enables a stable construction of the changing cubicle by the cabin crew.

In a further embodiment of the invention, one or more of the outer walls of the changing cubicle are formed as an access opening in the form of a door.

Simple entry and exit to and from the changing cubicle is thus enabled.

The changing cubicle may also comprise a floor, which can be folded up together with the outer walls.

An additional improvement in terms of hygiene is accordingly achieved, since the passengers no longer have to change clothes on the floor of the cabin.

In a further embodiment of the invention, the outer walls of the changing cubicle can be folded together.

This embodiment concerns a stocking-like embodiment of the changing cubicle, which for example can be lowered from a ceiling of the aircraft cabin.

In a further embodiment of the invention, the fastening means can be connected to a side wall of the aircraft cabin.

The changing cubicle can accordingly be constructed in an unused space within the aircraft cabin.

In a further embodiment of the invention, the fastening means can be connected to a ceiling of the aircraft cabin.

One or more of the outer walls of the changing cubicle may have a mirror, a surface on which objects can be placed, or a switch for activating an emergency alarm.

These additional elements may additionally increase comfort during use of the changing cubicle, either individually or in any combination.

One or more of the outer walls may be produced from a flexible material, preferably from cloth.

Flexible materials made of cloth enable the changing cubicle to be folded together in a space-saving manner after use and have merely a low net weight.

Furthermore, an aircraft comprising a cabin that has a changing cubicle as described above is disclosed.

The above-stated object is likewise achieved by a method for retrofitting an aircraft cabin of an aircraft with a changing cubicle.

The method comprises the following steps:
providing a changing cubicle, which comprises outer walls that are opaque, at least in part, and is designed with an access opening that can be closed, at least in part,
fastening the changing cubicle to the aircraft cabin by a fastening means, and
transferring the changing cubicle from a first state into a second state, wherein, in the first state, the outer walls of the changing cubicle are collapsed such that passengers can embark or disembark and, in the second state, passengers can change clothes.

In a further embodiment of the invention, the step of transfer into the second state is carried out after take-off of the aircraft, and a step of return from the second state into the first state is carried out before landing of the aircraft.

In a further embodiment of the invention, the step of fastening the changing cubicle is carried out in an embarking or disembarking region of the aircraft.

### BRIEF DESCRIPTION OF THE DRAWINGS

Some exemplary embodiments will be explained in greater detail hereinafter on the basis of the drawings, in which:

FIG. 1 shows a schematic illustration of a first embodiment of a changing cubicle according to the invention in an aircraft cabin,

FIGS. 2a to 2c show side views in which the changing cubicle according to FIG. 1 is unfolded,

FIG. 3 shows a schematic illustration of a second embodiment of a changing cubicle according to the invention in an aircraft cabin,

FIGS. 4a to 4e show plan views in which the changing cubicle according to FIG. 3 is unfolded,

FIGS. 5a to 5b show side views in which the changing cubicle according to FIG. 3 is unfolded, and

FIG. 6 shows a schematic illustration of an aircraft to be retrofitted with a changing cubicle according to the invention.

### DETAILED DESCRIPTION OF EXEMPLARY EMBODIMENTS

In the figures, like or functionally like components are provided with like reference signs.

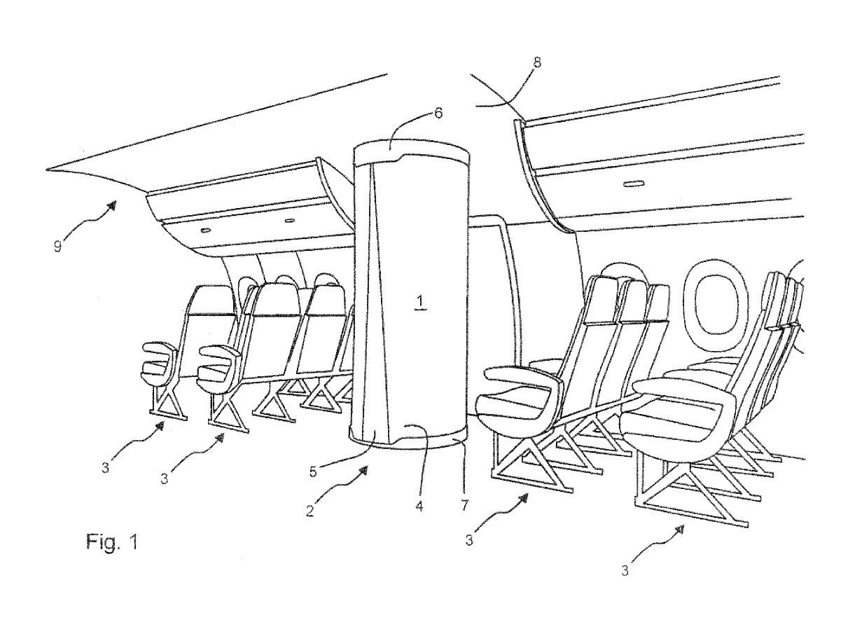

With reference to FIG. 1, an embodiment of the invention will be explained in greater detail hereinafter.

FIG. 1 shows a changing cubicle 1, which can be arranged in a region 2 between rows of seats 3. The changing cubicle 1 has outer walls 4 made of cloth, which are arranged such that an access opening 5 is provided. The outer walls 4 are opaque, at least in part, and are produced from a flexible cloth fabric. The access opening 5 can be closed, for example by means of buttons, a hook-and-loop fastener, or the like.

The outer walls 4 are arranged between an upper frame 6 and a lower frame 7. The upper frame 6 is connected to a ceiling 8 of an aircraft cabin 9. A suitable fastening means (not shown in FIG. 1) is provided for this purpose and may comprise a screw connection or a plug-in connection for example.

The changing cubicle 1 can be brought from a first state into a second state, wherein, in the first state, the outer walls 4 of the changing cubicle 1 are collapsed such that passengers can embark or disembark and, in the second state, passengers can change clothes.

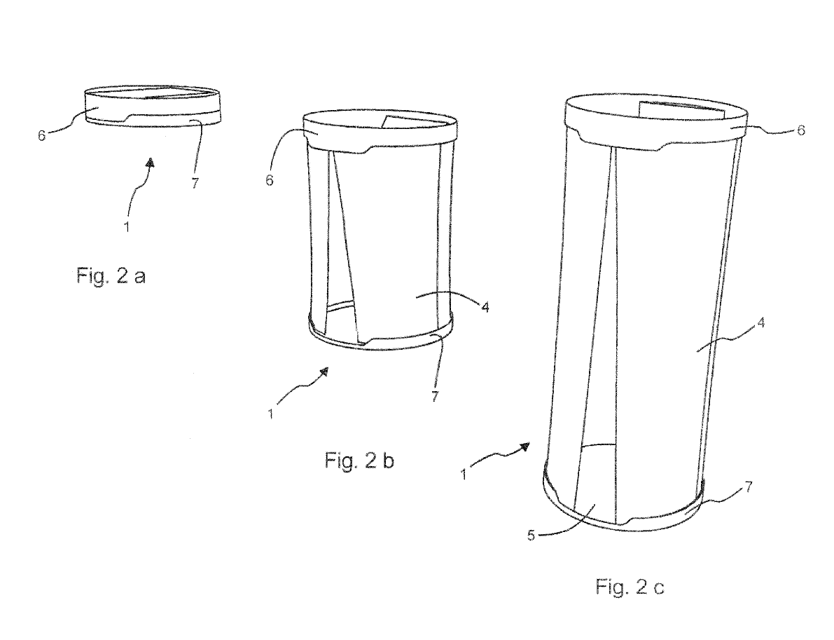

This is explained in greater detail in conjunction with FIGS. 2a to 2c. The changing cubicle 1 is shown in the first state in FIG. 2a. The lower frame 7 is connected to the upper frame 6 by means of a locking mechanism (not shown in FIG. 2a). Once the locking mechanism has been released by the cabin crew, the lower frame 7 can be drawn downwards, as is shown in FIG. 2b. The lower frame 7 can be fixed to the floor of the aircraft cabin 10. The changing cubicle 1 is then arranged in the second state. The changing cubicle 1 is then accessed via the gap-like access opening 5.

The changing cubicle 1 according to this exemplary embodiment can be integrated into the ceiling 8 or can be installed retrospectively on a ceiling panel of the ceiling 8. A mirror, one or more surfaces on which objects can be placed, and the like can additionally be created via an additional pivoting device (not shown in FIG. 1 or 2).

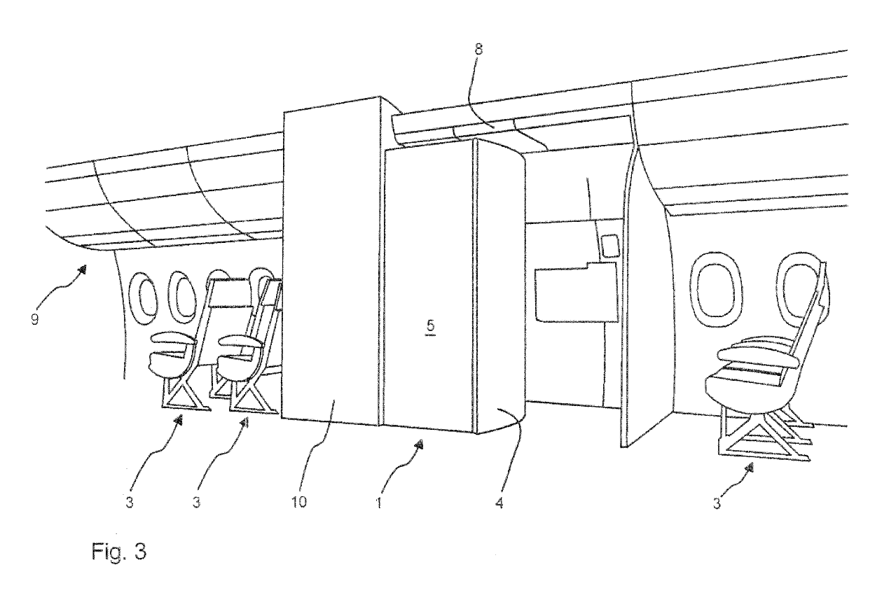

A second embodiment of the invention is shown in FIG. 3. The changing cubicle 1 is folding in this example. To this end, the changing cubicle 1 comprises two outer walls 4, and the access opening 5 is designed as a door. The two outer walls 4 can be brought from a first state, in which they are pushed together, into a second opened state.

In the first state, the outer walls 4 of the changing cubicle 1 are collapsed such that passengers can embark or disembark. In the second state, passengers can change clothes in the changing cubicle 1. The outer walls 4 of the changing cubicle 1 are slid apart from one another in a horizontal direction, and therefore the changing cubicle 1 is preferably fastened to a side wall. As is shown in FIG. 3, the changing cubicle 1 can be fastened to a partition wall 10.

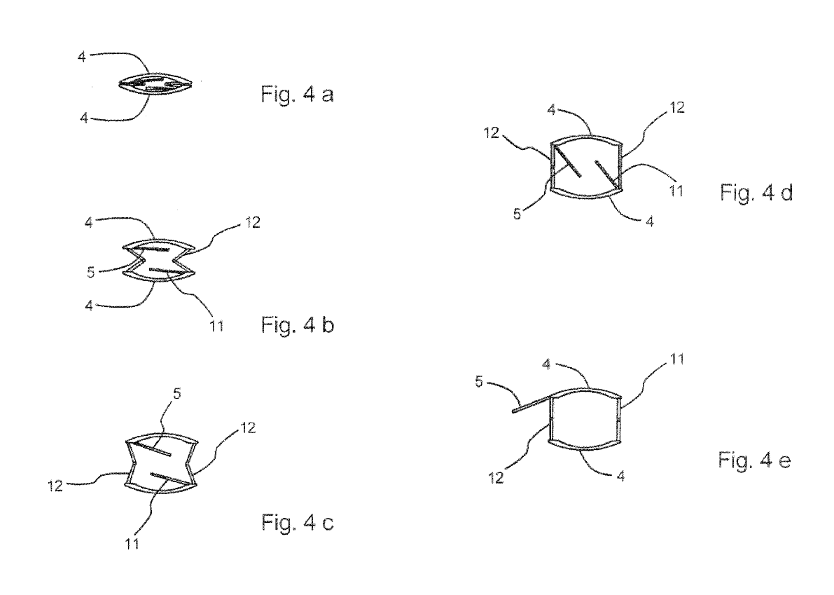

The way in which the outer walls 4 of the changing cubicle 1 are slid apart from one another will be explained again hereinafter with reference to FIGS. 4a to 4e. The changing cubicle 1 is shown in the first state in FIG. 4a, that is to say the changing cubicle 1 is folded up completely. In FIG. 4b, the cabin crew have now started to slide apart the two outer walls 4,

A panel as a rear wall 11 and a panel as an access opening 5 in the form of a door are attached between the two outer walls 4. The two outer walls 4 are held together via a corresponding kinematic system or guide 12, for example telescopic rods or the like provided with hinges.

The access opening 5 and the rear wall 11 are transferred successively in a forward or rearward direction as the outer walls are slid apart further, as shown in FIGS. 4c and 4d. Once the changing cubicle 1 has been unfolded completely, that is to say is in the second state, the changing cubicle 1 can be used. A fixing mechanism locks the outer walls in the second state in a manner that can be released by the cabin crew. One or more of the outer walls 4 or the rear wall of the changing cubicle 1 may have a mirror, a surface on which objects can be placed, or a switch for activating an emergency alarm.

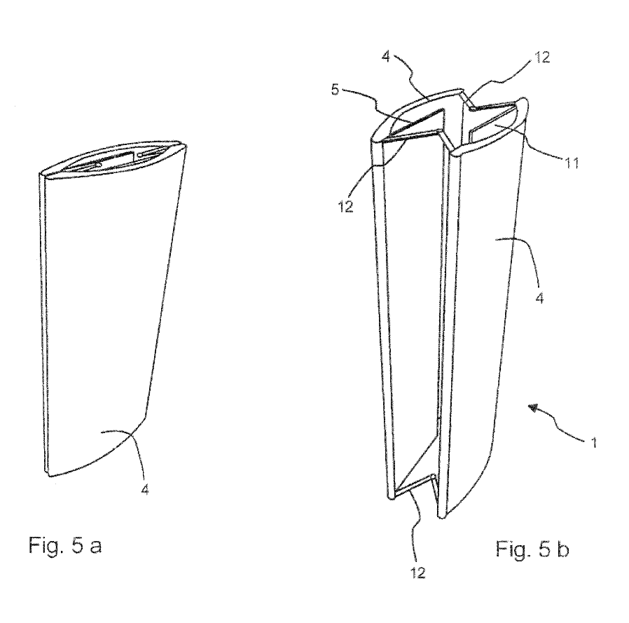

The sliding apart of the outer walls 4 of the changing cubicle 1 is shown in a side view with reference to FIGS. 5a and 5b. In FIG. 5b, the position of the access opening 5 and the rear wall 11 as well as the guide can be seen clearly.

In a further embodiment (not shown in FIGS. 3 to 5), the changing cubicle 1 may comprise a floor, which can be folded up together with the outer walls 4.

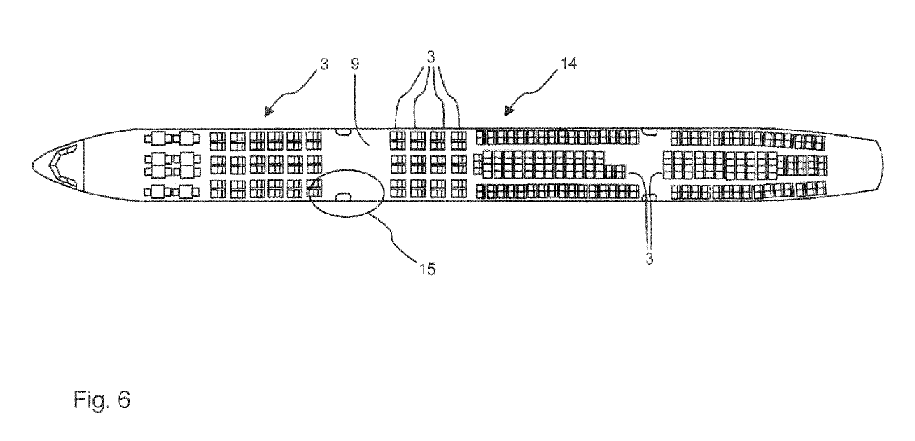

A schematic plan view of an aircraft 14 with a cabin 9 is shown in FIG. 6. The above-described changing cubicle 1 according to the invention can be installed in an embarking or disembarking region 15 of the aircraft. The embarking or disembarking region 15 is not required after take-off and before landing, and therefore the changing cubicle 1 can be provided in this region without the need to lose rows of seats 3.

Besides the step of providing the changing cubicle 1, a corresponding method for retrofitting of the aircraft cabin 9 of the aircraft 14 with the changing cubicle 1 by the cabin crew comprises a transfer of the changing cubicle 1 from a first state into a second state, wherein, in the first state, the outer walls 4 of the changing cubicle 1 are collapsed such that passengers can embark or disembark and, in the second state, passengers can change clothes.

The step of transfer into the second state is carried out after take-off of the aircraft 14, and a step of return from the second state into the first state is carried out before landing of the aircraft 14. The changing cubicle 1 is fastened in the embarking or disembarking region 15 of the aircraft 14.

### LIST OF REFERENCE SIGNS

1 changing cubicle
2 region
3 row of seats
4 outer wall
5 access opening
6 upper frame
7 lower frame
8 ceiling
10 side wall
11 rear wall
12 guide
14 aircraft
15 embarking or disembarking region

1. A changing cubicle in an aircraft, comprising outer walls that are opaque, at least in part, and being designed with an access opening that can be closed, at least in part, wherein the changing cubicle can be fastened to an aircraft cabin by a fastening means and can be brought from a first state into a second state, wherein, in the first state, the outer walls of the changing cubicle are collapsed such that passengers can embark or disembark and, in the second state, passengers can change clothes.

2. The changing cubicle according to claim 1, wherein the outer walls of the changing cubicle can be folded up.

3. The changing cubicle according to claim 2, wherein the outer walls of the changing cubicle are formed of a plurality of rectangular panels, which can be transferred from the first state into the second state by means of a folding device.

4. The changing cubicle according to claim 3, wherein the folding device is formed by means of hinges, which are arranged between the panels and have a fixing mechanism, which locks the outer walls releasably in the second state.

5. The changing cubicle according to claim 2, wherein one or more of the outer walls of the changing cubicle are formed as an access opening in the form of a door.

6. The changing cubicle according to claim 2, which also comprises a floor, which can be folded up together with the outer walls.

7. The changing cubicle according to claim 1, wherein the outer walls of the changing cubicle can be folded together.

8. The changing cubicle according to claim 1, wherein the fastening means can be connected to a side wall of the aircraft cabin.

9. The changing cubicle according to claim 1, wherein the fastening means can be connected to a ceiling of the aircraft cabin.

10. The changing cubicle according to claim 1, wherein one or more of the outer walls of the changing cubicle has a mirror, a surface on which objects can be placed, or a switch for activating an emergency alarm.

11. The changing cubicle according to claim 1, wherein one or more of the outer walls are produced from a flexible material, preferably from cloth.

12. An aircraft comprising a cabin that has a changing cubicle according to claim 1.

13. A method for retrofitting an aircraft cabin of an aircraft with a changing cubicle, said method comprising the following steps:
providing a changing cubicle, which comprises outer walls that are opaque, at least in part, and is designed with an access opening that can be closed, at least in part,
fastening the changing cubicle to the aircraft cabin by a fastening means, and
transferring the changing cubicle from a first state into a second state, wherein, in the first state, the outer walls of the changing cubicle are collapsed such that passengers can embark or disembark and, in the second state, passengers can change clothes.

14. The method according to claim 13, wherein the step of transfer into the second state is carried out after take-off of the aircraft and a step of return from the second state into the first state is carried out before landing of the aircraft.

15. The method according to claim 13, wherein the step of fastening the changing cubicle is carried out in an embarking or disembarking region of the aircraft.

16. The changing cubicle according to claim 11, wherein said flexible material is cloth.
